(19) United States
(12) Patent Application Publication
(10) Pub. No.: US 2002/0002687 A1
(43) Pub. Date: Jan. 3, 2002

(54) Method for enabling a user already connected to a virtual private network to communicate with a communication device not belonging to this virtual private network and corresponding network access server

(75) Inventors: Dominique Chantrain, Edegem (BE); Stephane Focant, Etterbeek (BE); Christian Hublet, Lochristi (BE); Christiaan Sierens, Mortsel (BE); Yves T'Joens, Sint Michiels-Brugge (BE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/891,545

(22) Filed: Jun. 27, 2001

(30) Foreign Application Priority Data
Jun. 30, 2000 (EP) 00 440 195.6

(51) Int. Cl. H04L 12/22; H04L 9/00

(52) U.S. Cl. 713/201; 713/162

(57) ABSTRACT

The invention relates notably to a method for enabling a user registered in an Network Access Server as already connected to a Virtual Private Network to communicate with at least a communication device not belonging to the Virtual Private Network. The Network Access Server enables access over a data communication network to the communication device as well as to a plurality of Virtual Private Networks.

According to the invention, the method consists in sending messages belonging to a communication between the user and the communication device over a logical channel between the Network Access Server and the communication device, where the logical channel refers to an identifier of the Virtual Private Network.

### BACKGROUND OF THE INVENTION

The present invention relates to data communication systems and more particularly to an access method implemented in a network access server for enabling end-users to access the core network.

The framework of this invention concerns the way individuals and companies are given access to interconnected data communication networks. Interconnected data communication networks consist for example of the public Internet and of a plurality of virtual private networks (VPN) operated by third parties. These third party VPNs may be corporate intranets to which external access is severely controlled, for example, by firewalls. External access to a third party VPN has however to be permitted for example for employees on travel to be able to access the corporate intranet by means of lap tops wherever they are located or for homeworking. This kind of external accesses to third party VPNs are usually provided by an access service provider owning a Network Access Server (NAS).

Several value-added services, proposed by access service providers, require that an end-user, while being connected to one third party VPN over a NAS, can simultaneously access to a local service network, called local VPN, associated to the NAS and usually operated by the access service provider, without disconnecting from the third party VPN.

An issue related to this kind of simultaneous access is due to addressing schemes. Heterogeneous interconnected networks are harmonized by all supporting the internet protocol IP or any of its variations. Usually and because of the restricted number of IP addresses available for an access service provider, the NAS uses overlapping address pools for different VPNs. As a consequence, two users connected to two different third party VPNs over the same NAS may have been attributed the same IP address. Thanks to the IP address and the identity of the VPN from which a message has been sent, the NAS can univocally distinguish the two users having the same IP address.

This becomes a problem if one of these users wants to be simultaneously connected to one identical further communication device without releasing the connection to its corresponding third party VPN. Such a communication device may be a server belonging to a VPN, called local VPN, associated to the NAS and owned by the access service provider. In that case, the NAS is no more able to distinguish them since both have the same IP address and get messages from the same local VPN.

A common method for solving this problem consists in introducing a network address translation (NAT) in the NAS. In this approach, the IP address of the user is translated in the NAS itself, such that for communication towards servers of the local VPN, each user appears to have a unique IP address. This approach has a number of important drawbacks: first of all it puts a heavy load on the NAS, since each IP packet flowing between the user and the local VPN has to be translated and as a consequence to be modified. Recent variations of the IP protocol, such as IPsec, rely on the fact that packets should not be altered between the endpoints, while NAT does alter them. As a consequence, this solution imposes some restrictions on the protocols that can be used, and hence on the services that can be offered.

A another method of solving this problem consists in allocating multiple IP addresses to the user. Depending on whether an given application is associated with a third party VPN or with the services in the local VPN, the application will use a different IP address to send its packets. This solution assumes that there is a well-controlled mechanism to specify for each application which IP address it has to use at a given point in time. This is extremely difficult to guarantee in case the same application is used to access subsequently services in different VPNs, e.g. if the user is browsing from a URL in VPN 1 to a URL in VPN 2. In other words, the solution is extremely complex to realize, since typically the access service provider has no control over the applications and protocol stacks running on the user terminal.

A particular object of the present invention is to provide a method that remains transparent for the end-user since none of them need to care about mechanism for distinguishing between several IP addresses.

Another object of the invention is to provide a method that does not too much overload the NAS.

### SUMMARY OF THE INVENTION

These objects, and others that appear below, are achieved by a method for enabling a user registered in an NAS as already connected to a VPN, called host VPN, to communicate with at least a communication device not belonging to the host VPN, the NAS having access over a data communication network to the communication device and to a plurality of VPNs. The method comprises a step of sending messages belonging to a communication between the user and the communication device over a logical channel between the NAS and the communication device, the logical channel referring to an identifier of the host VPN.

This method has the advantage that it does not require IP packet alteration.

The present invention also concerns a Network Access Server for enabling a communication between a user and a communication device, the user being registered in the Network Access Server as already connected to a Virtual Private Network, called host Virtual Private Network, the communication device being outside of the host Virtual Private Network, the Network Access Server being able to access to a database associating an identifier of the user to an identifier of the host Virtual Private Network. The Network Access Server further comprises means for sending messages originating from the user and destined to the communication device on a logical channel between the Network Access Server and the communication device, the logical channel referring to the identifier of the host Virtual Private Network.

The present invention concerns also a Network Access Server for univocally retrieving a user, out of a plurality of users, to which a message sent by a communication device and received at the Network Access Server is destined, the user being already connected over the Network access server to a Virtual Private Network not comprising the communication device, the Network Access Server being able to access to a database associating an identifier of the user to an identifier of the Virtual Private Network to which the user is already connected, wherein the Network Access Server comprises

a logical channel controller for determining a logical channel identifier of one logical channel on which said message is received at said Network Access server;

means for retrieving the user to which said message is destined, according to said logical channel identifier and said user entry in said database. This invention is based on a priority application EP 00 44 01 95 which is hereby incorporated by reference.

### BRIEF DESCRIPTION OF THE DRAWINGS

Other characteristics and advantages of the invention will appear on reading the following description of a preferred implementation given by way of non-limiting illustrations, and from the accompanying drawings, in which:

FIG. 1 shows a physical architecture of interconnected data communication networks where the present invention can be applied;

FIG. 2 shows an embodiment of a NAS according to the present invention.

### DETAILED DESCRIPTION OF THE INVENTION

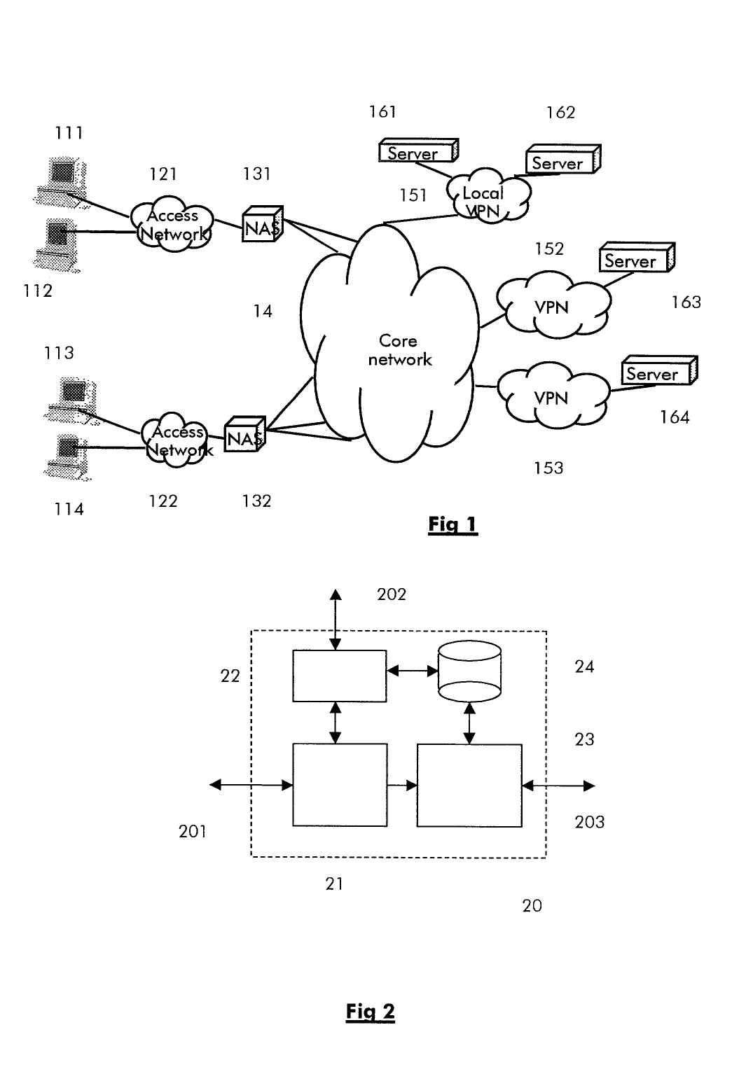

FIG. 1 shows a physical architecture of interconnected data communication networks comprising several VPNs 151, 152, 153 and access networks 121, 122 interconnected though a core network 14, for example the public Internet or leased lines.

End-users 111, . . . , 114 are connected over access networks 121, 122 to NASs 131, 132. NASs 131, 132 enable the access of end-users 111, . . . , 114 to the core network 14 and to the interconnected data communication networks 151, . . . , 153. Some servers 161, . . . , 164 belonging to the different VPN 151, . . . , 153 are represented on the figure by way of example. Servers 161 and 162 belongs to VPN 151, server 163 to VPN 152 and server 164 to VPN 153. These servers contain VPN specific information and preferably support features like authentication or authorization.

VPN 151 plays a privileged role in that it is preferably associated to NAS 131 and called local VPN in the following. For example, the NAS as well as the local VPN are owned by a single access service provider. This is however not a requirement of the invention. VPN 152 and 153 are preferably third party VPN for example corporate intranets.

Local VPN 151 may be interconnected to core network 14 as represented on the figure. Alternatively, local VPN 151 can also be directly connected to NAS 131. Several different NAS 131, 132 can be associated to the same local VPN 151.

Access networks 121 and 122 may be usual telephone networks like PSTN or ISDN or cable networks as well as radio networks.

If access networks 131, 132 are usual telephone networks, NASs 131, 132 comprise analog modems to terminate PSTN analog connections. In case of an ISDN digital connection, the signal need not to be demodulated. NASs 131, 132 also comprise a router function and a gateway to the core network.

In the description below, an example will be used to illustrate the invention. In this example, it is assumed that user 111 communicates with server 163 belonging to VPN 152. This communication takes place over NAS 131. It is also assumed that user 112 communicates with server 164 belonging to VPN 153. This communication also takes place over NAS 131.

Preferably, we consider a situation where a connection is currently established between user 111 and VPN 152 as well as between user 112 and VPN 153. These connections are preferably realized as PPP (Point to Point Protocol) connections between users 111, respectively 112, and NAS 131, respectively 132, in combination with appropriate routing table settings in NAS 131, respectively 132. Any other type of connections usually used in an access network may also be considered.

During connection set up, an IP address is allocated to the user requiring the connection and for the connection duration. During the connection set up, each user 111, 112 also indicates to the NAS 131 to which VPN it wants to connect.

As NAS 131 usually has a limited pool of IP addresses at its disposal, a single IP may be allocated to different users connected at the same time to NAS 131 on the condition that the users want to be connected to different VPN. To this extend, the IP address alone does not univocally identifies the user. As a consequence, only the association of the VPN to which a user is connected and its IP address univocally identify the user at the NAS. In this example, it is assumed that user 111 and user 112 are allocated the same IP address by the NAS 131 during the connection setup.

This complies with the above remark since both want to connect to different VPNs.

During connection setup, NAS 131 fills in a table comprising information related to connections to be established between users 111, 112 attached to NAS 131 and VPNs 152, 153. This information is held in the table for the whole duration of a connection. An entry of this table comprises preferrably a user identification specific to access network 121 (e.g. a calling number), the IP address allocated to that user and a VPN identifier indicating to which VPN that user is currently connected.

Assumed that in parallel to the already established connections, user 111 want to communicate simultaneously with server 161 located in local VPN 151 without releasing its connection to VPN 152. A message destined to server 161 comprising the source address of user 111 as well as the destination IP address of server 161 is sent to NAS 131. NAS 131 detects that, although user 111 is already connected to VPN 152, the message containing the destination IP address of server 161 should be directed toward VPN 151.

Assumed that server 161 were to answer to this message with an answer message directed to user 111, it would build an IP message containing as destination address the IP address of user 111 found in the received message. Upon reception of this answer message the NAS 131 will not be able to identify univocally that this answer message is destined to user 111 since user 112 also has the same IP address.

According to the invention, as soon as NAS 131 detects that a message is destined to a server 161 not belonging to the VPN 152 to which user 111 is registered as already connected, the message is directed on a logical channel having, as logical channel identifier, the identifier of VPN 152 to which user 111 is registered as already connected.

The principle of logical channels as such are generally known by those skilled in the art and are realized by means of several techniques.

The realization of logical channel between the NAS 131 and VPN 151 may be, for example, done by means of encapsulation. The NAS 131 should encapsulate each message destined to server 161 in a packet the header part of which containing an identifier of the VPN to which the user 111 is registered as already connected. A particular form of encapsulation, called tunneling, may also be used. One principle of tunneling is to encapsulate a protocol data corresponding to a certain layer in the OSI communication model in another protocol data corresponding to the same layer in the OSI communication model. This is advantageous in heterogeneous networks for privacy and security matters.

In case server 161 has to answer to a message sent by user 111 and received over a logical channel having an identifier of VPN 152 as logical channel identifier, server 161 sends back the answer message over the same logical channel. Upon reception of the answer message at the NAS 131, the latter identifies the logical channel identifier of the logical channel on which the message has been received and extracts the message from the logical channel. NAS 131 can univocally identify to which user the answer message is destined since it has access to the IP address contained in the answer message as well as to the identifier of the VPN to which the user is already connected. With this couple of information the NAS is able to identify univocally user 111.

An advantage of this method is that it is transparent for the end-users.

FIG. 2 shows an embodiment of a NAS according to the present invention. The NAS 20 comprises a forwarding engine 21, a logical channel controller 22, a routing part 23 and a table 24. NAS 20 comprises also three interfaces. A first interface 201 to access network and users, a second interface 202 to a local VPN (local VPN 151 shown on FIG. 1) and a third interface 203 to third party VPNs (VPN 152 and 153 shown on FIG. 1).

First interface 201 is connected to forwarding engine 21 which is in turn connected to logical channel controller 22 as well as to routing part 23. Logical channel controller 22 is connected to second interface 202 and routing part is connected to third interface 203. Logical channel controller 22 as well as routing part 23 can access to table 24. Table 24 is a database comprising entries registering the already established connections between a user, and an third party VPN. Each entry comprises an identification of the user specific to the access network to which this user is connected, the IP address of this user and an identifier of the third party VPN to which the user is connected. Other information may also be available in each entry.

Upon reception of a message on the first interface 200, forwarding engine 21 checks if this message is destined to the local VPN or to a third party VPN to which the user is already connected. This check is done by analyzing the destination IP address contained in the message.

If the message is destined to a third Party VPN. The message is transparently conveyed to routing part 23 and sent over third interface 202.

If the message is destined to the local VPN, the message is transmitted to logical channel controller 22. Logical channel controller 22 checks the source IP address contained in the message and searches in table 24 if this user is already connected to a third party VPN. If this is the case, it extracts the third party VPN identifier to which the user is already connected. Logical channel controller 22 then directs the message on a logical channel having as logical channel identifier the third party VPN identifier or any identifier univocally derived thereof. If the user is not connected to any VPN, a default reserved logical channel identifier is used to send the message to the local VPN.

Upon reception of a message on the second interface 201, logical channel controller 22 is responsible of finding to which VPN, if any, the user to which this message is destined is already connected to. For this purpose, logical channel controller 22 extracts the logical channel identifier of the channel on which the message has been received over interface 202. The VPN identifier may be identical to the logical channel identifier or univocally deduced thereof by means of an association table not represented on FIG. 2.

Logical channel controller 22 also extracts the destination IP address contained in the message. Then, logical channel controller 22 searches in table 24 the user corresponding to the IP address and the VPN identifier. This identifies univocally the user to which the message has to be transmitted. The message is then transmitted to forwarding engine 21 which sends the message on the first interface 200 to the identified user.

Alternatively to the embodiment described above, table 24 may not be contained in NAS 20. Table 24 may be stand alone and accessible by NAS 20 but also by other modules located out of the NAS, in particular modules residing on a server in the local VPN. Table 24 may also be shared by different NASes.

In another embodiment of the invention, it can be envisaged that two separate NASes treat separately the reception of a message on the first interface 200 and the reception of a message on the second interface 201.

1. Method for enabling a user registered in an Network Access Server as already connected to a Virtual Private Network, called host Virtual Private Network, to communicate with at least one communication device outside of said host Virtual Private Network, said Network Access Server having access over a data communication network to said communication device and to a plurality of Virtual Private Networks comprising said host Virtual Private Network, said method being characterized in that it comprises a step of sending messages belonging to a communication between said user and said communication device over a logical channel between said Network Access Server and said communication device, said logical channel referring to an identifier of said host Virtual Private Network.

2. Method according to claim 1, characterized in that it further comprises the steps of:
detecting at said Network Access Server a message from said user destined to said communication device; and
forwarding said message from said Network Access Server to said communication device over the logical channel referring to the identifier of said Virtual Private Network.

3. Method according to claim 1, characterized in that it further comprises the steps of:
detecting a message from said communication device being received at said Network Access Server on the logical channel referring to the identifier of a Virtual Private Network, said message containing a user destination address;
determining a user registered in said Network Access Server as already connected to said Virtual Private Network and corresponding to said destination address; and
forwarding said message from said Network Access Server to said user.

4. Method according to claim 1, characterized in that said messages belonging to the communication between said user and said communication device are encapsulated in data packets, said data packets comprising a field containing said identifier of said host Virtual Private Network or an indication derived of said identifier.

5. Method according to claim 4, characterized in that said messages belonging to the communication between said user and said communication device are sent over a tunnel having said identifier of said host Virtual Private Network as tunnel identifier.

6. Method according to claim 1, characterized in that said messages contain IP packets comprising an IP address of said user.

7. Method according to claim 1, characterized in that said communication device is a server belonging to a Virtual Private Network, called local Virtual Private Network, associated to said Network Access Server and different from said host Virtual Private Network.

8. Network Access Server for enabling a communication between a user and a communication device, said user being registered in said Network Access Server as already connected to a Virtual Private Network, called host Virtual Private Network, said communication device being outside of said host Virtual Private Network, said Network Access Server being able to access to a database associating an identifier of said user to an identifier of said host Virtual Private Network, said Network Access Server being characterized in that it further comprises means for sending messages originating from said user and destined to said communication device on a logical channel between said Network Access Server and said communication device, said logical channel referring to said identifier of said host Virtual Private Network.

9. Network Access Server for univocally retrieving a user, out of a plurality of users, to which a message sent by a communication device and received at said Network Access Server is destined, said user being already connected over said Network access server to a Virtual Private Network not comprising said communication device, said Network Access Server being able to access to a database associating an identifier of said user to an identifier of said Virtual Private Network to which said user is already connected, said Network Access Server being characterized in that it comprises
a logical channel controller for determining a logical channel identifier of one logical channel on which said message is received at said Network Access server;
means for retrieving the user to which said message is destined, according to said logical channel identifier and said user entry in said database.
